(19) United States
(12) Patent Application Publication
(10) Pub. No.: US 2023/0329465 A1
(43) Pub. Date: Oct. 19, 2023

(54) Thermotropic Glass Shell for Kitchenware and Utensils

(71) Applicant: Kandis Lattimore, Covington, GA (US)

(72) Inventor: Kandis Lattimore, Covington, GA (US)

(21) Appl. No.: 18/179,476

(22) Filed: Mar. 7, 2023

Related U.S. Application Data
(60) Provisional application No. 63/330,950, filed on Apr. 14, 2022.

(51) Int. Cl. A47G 19/22; A47G 21/04; A61J 11/00; G02F 1/13; B32B 17/06; A47G 21/02; A47G 19/02

(52) U.S. Cl. CPC A47G 19/2227; A47G 19/025; A47G 21/023; A47G 21/04; A61J 11/0075; B32B 17/06; G02F 1/132; A47G 2021/008; B32B 2307/748

(57) ABSTRACT

The present invention relates to a thermotropic liquid crystal glass in a crystal or quartz shell for indicating a temperature of a food item and thereby preventing individuals from consuming food at undesirable temperatures or accidentally touching or consuming items that are too hot or too cold. The glass shell includes a plurality of thermotropic liquid crystals that absorbs heat from food items and changes color to exhibit at least one of violet blue, blue, green, yellow/amber, brown, gray, and black color. The hot food causes crystals to change to violet blue and alternatively, when exposed to cold food, the crystals turn black. In some embodiments, kitchenware can be integrated with the glass shell or alternatively, can be detachably attached to the kitchenware. In exemplary embodiments, the glass shell can be positioned onto dishware (i.e., plates, bowls, cups, and mugs) and metal utensils (i.e., forks, spoons, and knives).

### CROSS-REFERENCE TO RELATED APPLICATION

The present application claims priority to, and the benefit of, U.S. Provisional Application No. 63/330,950, which was filed on Apr. 14, 2022, and is incorporated herein by reference in its entirety.

### FIELD OF THE INVENTION

The present invention relates generally to the field of a temperature sensing device and methods. More specifically, the present invention relates to a novel glass shell containing thermotropic liquid crystals that can be strategically placed onto kitchenware or utensils. The crystals absorb the heat from a food item placed on kitchenware or utensils and exhibit a color for visually indicating temperature range of the food item. The glass shell can be positioned or secured onto plates, bowls, cups, mugs, forks, spoons, knives, and more for preventing individuals from consuming food at undesirable temperatures or accidentally touching or consuming items that are too hot. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals while eating food and drinking beverages are unaware of the actual temperature range of the food and beverage until a bite or a sip is taken by them. While having a first bite, individuals find out that food may be too hot, too cold, or not done at all. The first bite may make their experience unpleasant. When the food is too hot, serious burn injuries and harm can occur. In fact, any type of hot food or liquid has the potential to irritate the lining of the mouth, throat, and esophagus. Eating or drinking something that is too hot can cause a thermal injury in the lining of the mouth, throat, or esophagus and can lead to chronic inflammation and the formation of cancer cells. Acute esophagus thermal injury (ETI) is considered a reversible esophagus injury as a result of ingestion of hot foods and hot beverage, leading to dysphagia, odynophagia, and retrosternal burning sensation.

When the food is too cold, it can cause a sensation in the teeth of a user and can also cause a sore throat. Cold items that are not warmed or not finished thoroughly offer the inconvenience and unpleasant experience of needing to be reheated or recooked. This can also lead to customer dissatisfaction and loss of reputation when experienced commercially. Chefs and other individuals working in kitchens may touch food items that are too hot causing them burn injuries. Individuals desire a device and a method to improve their mealtime experience by consuming food and beverages at safe or optimum temperature while allowing restaurants to improve customer satisfaction and safe handling of hot food items.

Therefore, there exists a long-felt need in the art for utensils and dishware for storing and consuming food at safe and desirable temperatures. There is also a long-felt need in the art for dishware that allows individuals to detect if a food item is too hot or too cold before consumption. Additionally, there is a long-felt need in the art for a device that prevents serious burn injuries and harm that can occur to a consuming user in the event the food item is too hot. Moreover, there is a long-felt need in the art for a liquid crystal glass product that can be attached to existing dishware and utensils for preventing individuals from consuming food at undesirable temperatures or accidentally touching items that are too hot. Further, there is a long-felt need in the art for a temperature indicating shell that can be attached to existing kitchenware and utensils for improving mealtime experience of individuals. Finally, there is a long-felt need in the art for a simple device that can be used by chefs, operators, and individuals with kitchenware, dishware, and utensils for safely holding and consuming hot and cold food items.

The subject matter disclosed and claimed herein, in one embodiment thereof, comprises a flexible and anti-microbial glass shell containing thermotropic liquid crystals configured to change colors when the kitchenware or utensils are exposed to temperatures of different foods. The glass shell is integrally or detachably attached to the kitchenware or utensils. More specifically, the glass shell comprising a plurality of temperature sensitive thermotropic liquid crystals that possess a phase with crystal and liquid properties within a temperature range from about -30° C. (-22° F.) to about 115° C. (248° F.). Within five (5) seconds of exposure to temperature of food items, the liquid crystals are configured to change color for visually indicating temperature range of the food item and thereby preventing a user from touching or consuming too hot or too cold food items.

In this manner, the thermotropic glass shell of the present invention accomplishes all of the forgoing objectives and provides users with a thermotropic liquid crystal glass in a variety of user creative shapes and designs to attach to kitchenware, dishware, and utensils for allowing users to identify the temperature of food due to the change in color of crystals. The glass shell prevents individuals from consuming food at undesirable temperatures or accidentally touching or consuming items that are too hot. Further, the glass shell improves mealtime experience and ensures individuals can accurately handle and consume food at a safe and desired temperature.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a glass shell containing thermotropic liquid crystals. The glass shell is designed to be strategically placed onto kitchenware or utensils and configured to change colors when the kitchenware or utensils are exposed to temperatures of different foods. More specifically, the glass shell comprising a plurality of thermotropic liquid crystals, the liquid crystals include anisotropic liquids possessing a phase with crystal and liquid properties within temperature range from about -30° C. (-22° F.) to about 115° C. (239° F.), wherein the liquid crystals are configured to change color upon detecting temperature of a food item for visually indicating temperature range of the food item and thereby preventing a user from touching or consuming too hot or too cold food item.

In a further embodiment of the present invention, a utensil with an integrated thermotropic glass shell is disclosed. The glass shell can be integrated to the utensil during manufacturing of the utensil. The glass shell is flexible and conforms to the shape of the utensil. The glass shell includes a plurality of thermotropic liquid crystals configured to change color when the utensil is exposed to the temperature of a food item placed thereon, such that the food item touches the glass shell. The glass crystals exhibit a violet blue color for indicating hot food and exhibit black color for indicating cold food.

In a further embodiment of the present invention, a method for indicating temperature of a food item to a user is described. The method includes the steps of providing a glass shell including thermotropic liquid crystals; detachably attaching the glass shell on a kitchenware; placing a food item on the kitchenware; changing color of the thermotropic liquid crystals when the kitchenware is exposed to temperature range of the food item, wherein, the color exhibited by the thermotropic liquid crystals can be one of violet blue, blue, green, yellow/amber, brown, gray, and black for indicating a particular temperature range of the food item.

In a further embodiment of the present invention, the glass shell is dishwasher safe and reusable.

In a further embodiment of the present invention, glass shell including the crystals exhibit black color in the temperature range from about -30° C. to about 5° C., grey color in the temperature range from about 6° C. to about 15° C., brown color in the temperature range from about 16° C. to about 30° C., amber color in the temperature range from about 31° C. to about 45° C., green color in the temperature range from about 46° C. to about 79° C., blue color in the temperature range from about 80° C. to about 100° C., and violet blue color in the temperature range from about 101° C. to about 115° C.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a thermotropic glass shell of the present invention in accordance with the disclosed architecture;

FIG. 2 illustrates another embodiment of the thermotropic glass shell of the present invention integrated to a fork in accordance with the disclosed architecture;

FIG. 3 illustrates different exemplary colors exhibited by the glass shell of the present invention corresponding to different temperature ranges of food items in contact in accordance with the disclosed architecture;

FIG. 4 illustrates a flow diagram depicting a process of using the thermotropic glass shell of the present invention for indicating a food item temperature in accordance with the disclosed architecture;

FIG. 5A illustrates a bottle nipple shaped thermotropic glass shell of the present invention in accordance with the disclosed architecture; and

FIG. 5B illustrates the thermotropic spoon with integrated glass shell for eating a dessert in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for utensils and dishware for storing and consuming food at safe and desirable temperatures. There is also a long-felt need in the art for dishware that allows individuals to detect if a food item is too hot or too cold before consumption. Additionally, there is a long-felt need in the art for a device that prevents serious burn injuries and harm that can occur to a consuming user in the event the food item is too hot. Moreover, there is a long-felt need in the art for a liquid crystal glass product that can be attached to existing dishware and utensils for preventing individuals from consuming food at undesirable temperatures or accidentally touching items that are too hot. Further, there is a long-felt need in the art for a temperature indicating shell that can be attached to existing kitchenware and utensils for improving mealtime experience of individuals. Finally, there is a long-felt need in the art for a simple device that can be used by chefs, operators, and individuals with kitchenware, dishware, and utensils for safely holding and consuming hot and cold food items.

The present invention, in one exemplary embodiment, is a method for indicating temperature of a food item to a user. The method includes the steps of providing a glass shell including thermotropic liquid crystals, detachably attaching the glass shell on a kitchenware, placing a food item on the kitchenware, changing color of the thermotropic liquid crystals when the kitchenware is exposed to the temperature range of the food item, wherein, the color exhibited by the thermotropic liquid crystals can be one of violet blue, blue, green, yellow/amber, brown, gray, and black for indicating a particular temperature range of the food item.

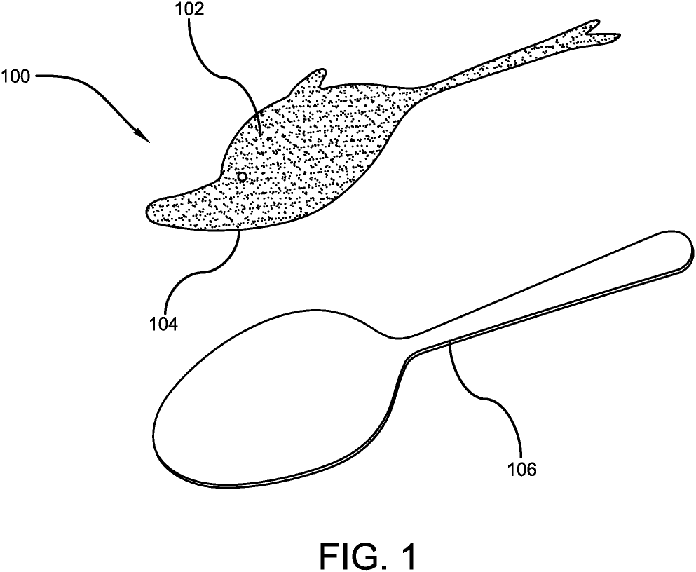

Referring initially to the drawings, FIG. 1 illustrates a perspective view of one potential embodiment of a thermotropic glass shell of the present invention in accordance with the disclosed architecture. The thermotropic glass shell 100 of the present invention is designed to strategically place onto kitchenware, utensils, and dishware such that when the dishware or utensils are exposed to temperatures of different foods, the glass shell 100 changes color allowing users to visually identify whether a desired temperature is achieved of the food item. The glass shell 100 can be designed to emulate shapes and sizes of different types of dishware and utensils such that the shell 100 can be used with all types of existing dishware. In the present embodiment, the shell 100 is substantially spoon shaped allowing a user to detachably or integrally attached to a dishware 106 such as a spoon.

More specifically, the thermotropic glass shell 100 contains a plurality of thermotropic liquid crystals 102 configured to change color indicating a temperature range. The crystals 102 can coat a transparent glass substrate 104 which can be made of crystal or quartz shell wherein the thermotropic crystals 102 depend upon temperature for changing colors thereof. In fact, temperature is the only fundamental thermodynamic parameter that controls and determines liquid crystalline mesophase order and formation of the thermotropic liquid crystals. Liquid crystals 102 represent a phase between liquid and solid and the molecules in a liquid crystal move independently, as in a liquid, but remain somewhat organized, as in a crystal. In exemplary embodiments, as the temperature of the liquid crystals increase, their color changes from red to orange, to yellow, to green, to blue, and to purple. When liquid crystals 102 are exposed to extremely hot food, their color changes to violet blue and alternatively, when exposed to cold food such as a cold drink or an ice crush, the crystals 102 turn black.

In the hot nematic stage of the crystals 102, they are closest to the liquid phase where the molecules are freely moving around and only partly ordered. In the cold smectic stage, they are closest to a solid phase where the molecules align themselves into tightly wound chiral matrixes.

In use, as the utensil 106 is exposed to temperatures of different foods, the crystals 102 embedded in the shell 100 absorb the temperature and subsequently identify the temperature range of the food. Accordingly, a user knows the temperature range of the food item even before the first bite and thus prevents food burn and associated problems.

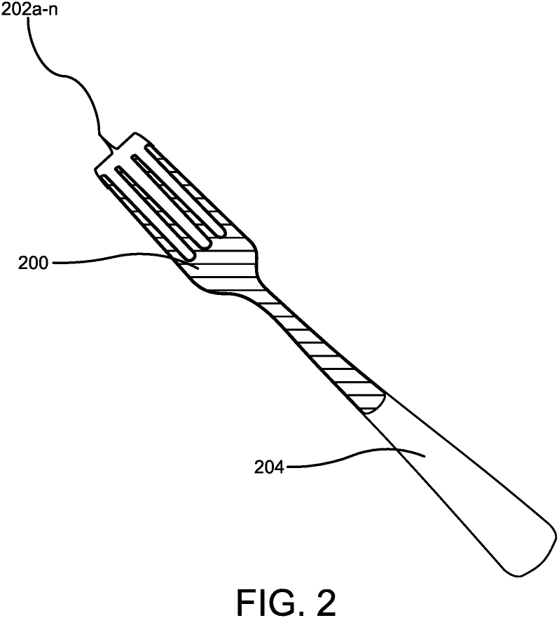

FIG. 2 illustrates another embodiment of the thermotropic glass shell of the present invention integrated to a fork in accordance with the disclosed architecture. In the present embodiment, the glass shell 200 is formed in the shape of a fork having a plurality of fingers 202an such that the shell 200 is integrated on the fork 204 during manufacturing of the fork 204. The shell 200 includes plurality of thermotropic liquid crystals as described in FIG. 1 for changing color to indicate temperature of a food item which is in contact with the fork 204.

In some embodiments, the glass shell 200 may have an adhesive layer for detachably attaching the shell 200 to the fork 204. The glass shell of different embodiments of the present invention is dishwasher safe and reusable and can indicate any temperature of food item which is in contact with the thermotropic glass shell. In different embodiments of the present invention, the glass shell containing thermotropic liquid crystals helps in non-intrusively visualizing instantaneous surface temperature changes of dishware or utensil and has a temperature range from about -30° C. (-22° F.) to about 115° C. (239° F.) with a temperature sensitivity of about 0.1° C.

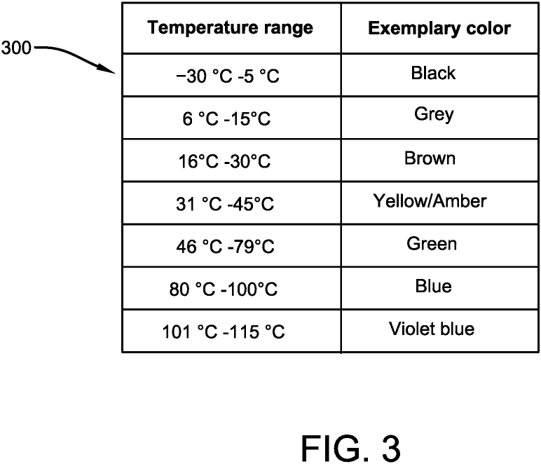

FIG. 3 illustrates different exemplary colors exhibited by the glass shell of the present invention corresponding to different temperature ranges of food items in contact in accordance with the disclosed architecture. As illustrated in the table 300, if the temperature range of the food placed on the glass shell containing thermotropic liquid crystals is in between -30° C. and 5° C., then, color exhibited by the glass shell is black. If the temperature range of the food placed on the glass shell containing thermotropic liquid crystals is between 6° C. and 15° C., then, color exhibited by the glass shell is grey.

When the temperature range of the food placed on the glass shell containing thermotropic liquid crystals is between 16° C. and 30° C., then, color exhibited by the glass shell is brown and when the temperature range is between 31° C. and 45° C., then yellow or amber. When the temperature increases, and for preventing a user from burning, green color is exhibited when temperature is in the range of 46° C. to 79° C. and blue color is exhibited when temperature is in the range of 80° C. and 100° C. For indicating temperature above 100° C., violet blue color is exhibited by the glass shell.

It should be noted that any other combination of colors at any temperature range can be exhibited by the glass shell containing the thermotropic liquid crystals of the present invention. The glass shell is food safe and also offers ideal dishware for safely feeding babies and toddlers during mealtime.

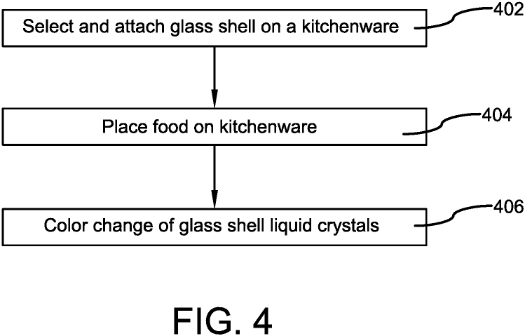

FIG. 4 illustrates a flow diagram depicting a process of using the thermotropic glass shell of the present invention for indicating a food item temperature in accordance with the disclosed architecture. Initially, the glass panel of a desired shape and size is strategically placed on a kitchenware to be used for serving or consuming a food item (Step 402). In one embodiment, the glass panel can be strategically integrated on the kitchenware. Then, a food item whether hot or cold is placed on the kitchenware such that the food item touches the thermotropic glass shell (Step 404). Within a few seconds, the color of the crystals included in the glass shell changes color for indicating the temperature range of the food item (Step 406). This ensures that individuals can accurately handle and consume food at a safe and desired temperature and visual color identification prevents individuals from consuming food at undesirable temperatures or accidentally touching or consuming items that are too hot or too cold.

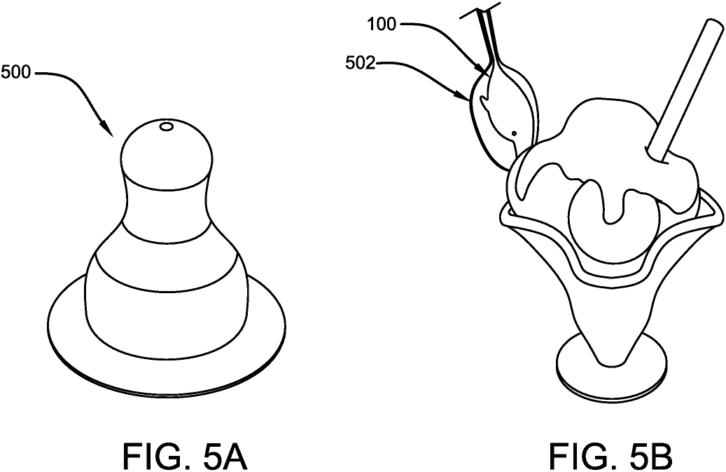

FIG. 5A illustrates a bottle nipple shaped thermotropic glass shell of the present invention in accordance with the disclosed architecture. The glass shell 500 of the present embodiment is flexible and is shaped in the form of a nipple such that the shell 500 can be used for safely feeding babies and toddlers during mealtime. Color of the shell 500 indicates to a user of a temperature range of food and thus infants can be prevented from exposure to hot or cold items.

FIG. 5B illustrates the thermotropic spoon with integrated glass shell for eating a dessert in accordance with the disclosed architecture. The spoon 502 has the glass shell 100 integrated thereon, thus, preventing a user from attaching and removing the shell 100 from the spoon 502. The shell provides a change in color instantly to indicate a temperature range of the food item and thus prevents individuals from having an unpleasant food eating experience.

The glass shell with thermotropic liquid crystals can be made in any size and shape and can be used both personally and commercially by restaurants for providing safe serving and eating of both hot and cold food items.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “glass shell”, “thermotropic glass shell”, “shell”, and “glass shell with thermotropic liquid crystals” are interchangeable and refer to the glass shell with thermotropic liquid crystals 100, 200, 500 of the present invention.

Notwithstanding the forgoing, the glass shell with thermotropic liquid crystals 100, 200, 500 of the present invention can be of any suitable size and configuration as is known in the art without affecting the overall concept of the invention, provided that it accomplishes the above-stated objectives. One of ordinary skill in the art will appreciate that glass shell with thermotropic liquid crystals 100, 200, 500 as shown in the FIGS. are for illustrative purposes only, and that many other sizes and shapes of the glass shell with thermotropic liquid crystals 100, 200, 500 are well within the scope of the present disclosure. Although the dimensions of the glass shell with thermotropic liquid crystals 100, 200, 500 are important design parameters for user convenience, the glass shell with thermotropic liquid crystals 100, 200, 500 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A thermotropic glass shell for use with a kitchenware utensil comprising:
a thermotropic glass substrate detachably attached to the kitchenware utensil;
wherein said thermotropic glass substrate having a plurality of thermotropic liquid crystals coated thereon;
wherein said thermotropic liquid crystals are temperature sensitive and change to a plurality of colors corresponding to a plurality of temperature ranges;
wherein a distinct color of said plurality of colors indicating a distinct temperature range of said plurality of temperature ranges; and
further wherein said plurality of temperature ranges is from about -30° C. to about 115° C.

2. The thermotropic glass shell of claim 1, wherein each said distinct color identifies each said distinct temperature range.

3. The thermotropic glass shell of claim 2, wherein said plurality of temperature ranges generated from contact of said kitchenware utensil with a plurality of foods.

4. The thermotropic glass shell of claim 1, wherein said thermotropic glass substrate is a crystal shell.

5. The thermotropic glass shell of claim 1, wherein said thermotropic glass substrate is a quartz shell.

6. The thermotropic glass shell of claim 1, wherein said kitchenware utensil is selected from a group consisting of a metal utensil, a dishware, and a bottle nipple.

7. The thermotropic glass shell of claim 3, wherein said thermotropic liquid crystals move from a hot nematic stage when in a hot temperature range to a cold smectic stage when in a cold temperature range.

8. The thermotropic glass shell of claim 3, wherein said thermotropic liquid crystals move from a generally liquid phase when in a hot temperature range to a generally solid phase when in a cold temperature range.

9. The thermotropic glass shell of claim 3, wherein said thermotropic glass substrate having an adhesive layer for said detachably attaching said thermotropic glass substrate to said kitchen utensil.

10. The thermotropic glass shell of claim 1, wherein said thermotropic liquid crystals having at least a first color associated with a first temperature range, a second color associated with a second temperature range, a third color associated with a third temperature range, a fourth color associated with a fourth temperature range, a fifth color associated with a fifth temperature range, a sixth color associated with a sixth temperature range, and a seventh color associated with a seventh temperature range.

11. The thermotropic glass shell of claim 10, wherein said thermotropic liquid crystals said first color is black and said first temperature range is from about -30° C. to about 5° C.

12. The thermotropic glass shell of claim 11, wherein said thermotropic liquid crystals said second color is grey and said second temperature range is from about 6° C. to about 15° C.

13. The thermotropic glass shell of claim 12, wherein said thermotropic liquid crystals said third color is brown and said third temperature range is from about 16° C. to about 30° C.

14. The thermotropic glass shell of claim 13, wherein said thermotropic liquid crystals said fourth color is yellow and said fourth temperature range is from about 31° C. to about 45° C.

15. The thermotropic glass shell of claim 14, wherein said thermotropic liquid crystals said fifth color is green and said fifth temperature range is from about 46° C. to about 79° C.

16. The thermotropic glass shell of claim 15, wherein said thermotropic liquid crystals said sixth color is blue and said sixth temperature range is from about 80° C. to about 100° C.

17. The thermotropic glass shell of claim 16, wherein said thermotropic liquid crystals said seventh color is violet blue and said seventh temperature range is from about 101° C. to about 115° C.

18. A thermotropic glass shell for use with a kitchenware utensil comprising:
a thermotropic glass substrate conformed to the kitchenware utensil;
wherein said thermotropic glass substrate having a plurality of thermotropic liquid crystals;
wherein said thermotropic liquid crystals are temperature sensitive and change to a plurality of colors corresponding to a plurality of temperature ranges;
wherein a distinct color of said plurality of colors indicating a distinct temperature range of said plurality of temperature ranges;
wherein said plurality of temperature ranges is from about -30° C. to about 115° C.; and
further wherein said kitchenware utensil is a bottle nipple.

19. A thermotropic glass shell for use with a kitchenware utensil comprising:
a thermotropic glass substrate conformed to the kitchenware utensil;
wherein said thermotropic glass substrate having a plurality of thermotropic liquid crystals;
wherein said thermotropic liquid crystals are temperature sensitive and change to a plurality of colors corresponding to a plurality of temperature ranges;
wherein a distinct color of said plurality of colors indicating a distinct temperature range of said plurality of temperature ranges;
wherein each said distinct color identifies each said distinct temperature range; and
further wherein said plurality of temperature ranges generated from contact of said kitchenware utensil with a plurality of foods.

20. The thermotropic glass shell of claim 19, wherein said kitchenware utensil is selected from a group consisting of a metal fork, a metal spoon, a metal knife, a plate, a bowl, a cup, and a mug.
